(19) United States
(12) Patent Application Publication
(10) Pub. No.: US 2007/0050986 A1
(43) Pub. Date: Mar. 8, 2007

(54) Combination basting brush, spoon, and spatula

(76) Inventors: Gregory J. Foster, Chicago, IL (US); Robert W. Sheldon, Winnetka, IL (US)

Correspondence Address: Paul E Schaafsma;NovusIP, LLC, Suite 221, 521 West Superio Street, Chicago, IL, 60610-3135, US

(21) Appl. No.: 11/516,903

(22) Filed: Sep. 7, 2006

Related U.S. Application Data
(60) Provisional application No. 60/714,987, filed on Sep. 8, 2005.

(51) Int. Cl. A47J 43/28

(52) U.S. Cl. 30/142; 30/324

(57) ABSTRACT

In accordance with the principles of the present invention, a combination basting brush, spoon, and spatula is provided that combines the functionality of a basting brush, spoon, and spatula in one device. The combination basting brush, spoon, and spatula comprising a handle portion and a combined concave spoon portion, spatula edge portion, and bristle portion. The present invention enables a user to perform multiple tasks in a more efficient manner.

### CROSS-REFERENCE TO RELATED APPLICATIONS

This application is based on U.S. Provisional Patent Application Ser. No. 60/714,987 titled, “Combination Basting Brush, Spoon, and Spatula,” filed Sep. 8 2005.

### FIELD OF THE INVENTION

The present invention relates to cooking utensils.

### BACKGROUND OF THE INVENTION

When cooking meats or other food items, a condiment such as barbeque sauce, ketchup or marinate is often applied to enhance flavor. Some chefs prefer to spread the condiment over the food item for even distribution to obtain a more consistent flavor. Present practice is to use a small brush to achieve such spreading. Current basting brushes on the market perform like traditional paint brushes when basting. These simply spread sauces over food with a flimsy bristle. These bristles are too soft and do not allow for any real control in “scooping-out” the sauce (from a jar or bowl), applying it, and/or scraping the jar or bowl sides clean to eliminate waist.

In addition, over time the bristles of these brushes often become contaminated with food and grease residues which decompose and harden. Microbial organisms which thrive on the food and grease residues may be inadvertently transferred to fresh meats and other foods during further use of the basting brush, and therefore pose a potentially significant health risk. Because the organic food residues tend to be concealed in nooks and crannies of the basting brush, inaccessible to typical washing procedures, the brush is rendered essentially uncleanable and therefore unusable. After a short period of time, these residue-clogged basting brushes become aesthetically and hygienically unappealing for continued use, and are discarded even though the handle portions of the brushes remain useful and their disposal is economically wasteful. Thus, what is needed is a device that would enhance the hygiene and appeal of reusing the brush, and therefore alleviate the waste of brush handles.

Still further, when cooking meats and similar food items, a user often intermittently applies marinades, sauces, and similar condiments to enhance the flavor of the meat and to prevent the meat from drying out. A spoon is typically used to do so. Once the sauce is applied, it is often desirable to evenly distribute the sauce over the exterior surface of the meat to assure that the entirety of the meat is evenly coated. Accordingly, a user must maintain a brush or similar utensil nearby.

Once the spoon and the brush are initially used, they must be continuously held which is inconvenient; alternatively, it must be placed on a support surface which can promote unsanitary conditions as the spoon and the brush are often placed on a countertop after use, which transfers a small amount of condiment to the countertop, giving rise to a breeding area for bacteria. What would be desirable is a device for applying condiments to foods without risk of contacting the applicator to a countertop or other surface upon which bacteria can survive. It would further be desirable to provide a device that would enhance the hygiene and appeal of reusing the brush, and therefore alleviate the waste of brush handles.

### SUMMARY OF THE INVENTION

A device in accordance with the principals of the present applies condiments to foods without risk of contacting the applicator to a countertop or other surfaces upon which bacteria can survive. A device in accordance with the principals of the present enhances the hygiene and appeal of reusing the brush, and therefore alleviate the waste of brush handles. In accordance with the principles of the present invention, a combination basting brush, spoon, and spatula is provided that combines the functionality of a basting brush, spoon, and spatula in one device. The combination basting brush, spoon, and spatula comprising a handle portion and a combined concave spoon portion, spatula edge portion, and bristle portion. The present invention enables a user to perform multiple tasks in a more efficient manner.

### BRIEF DESCRIPTION OF THE DRAWINGS

FIG. 1 is perspective view of a combination basting brush, spoon, and spatula in accordance with the principles of the present invention.

FIG. 2 is an overhead view of a combination basting brush, spoon, and spatula in accordance with the principles of the present invention.

FIG. 3 is elevated side-view of a combination basting brush, spoon, and spatula in accordance with the principles of the present invention.

### DETAILED DESCRIPTION OF THE INVENTION

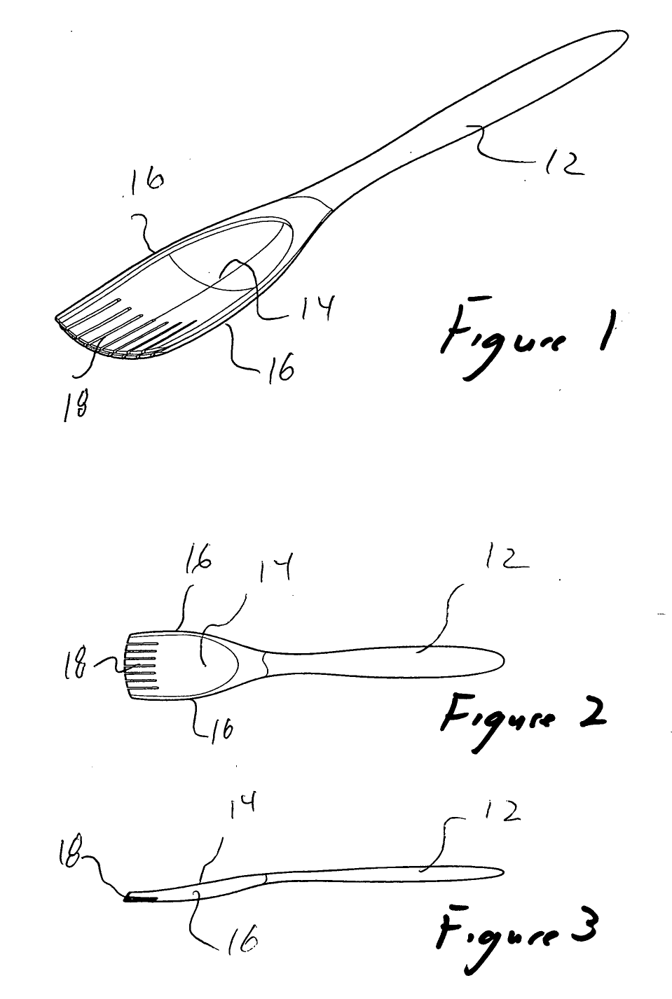

Referring to FIG. 1, a perspective view of a combination basting brush, spoon, and spatula in accordance with the principles of the present invention is seen. The combination basting brush, spoon, and spatula of the present invention is a unique 3-in-1 cooking utensil combining the functionalities of a spoon, spatula, and basting brush into one device. The spoon aspect allows users to scoop large portions of basting sauce. The spatula aspect allows users to scrap the sides of a vessel clean without wasting any sauce and the basting bristles allow for efficient basting capabilities.

The device 10 integrally comprises a handle portion 12, a concave spoon portion 14, a spatula edge portion 16, and a bristle portion 18. The handle portion 12 may be constructed from a variety of materials. The handle portion 12 can be in an ergonomic shape and can be made of a soft material that provides good grip and comfort when used for long periods and when hands are wet. In one embodiment, the handle portion 12 can comprise a one piece molded silicon with the concave spoon portion 14, spatula edge portion 16, and bristle portion 18. Alternatively, the handle portion 12 can comprise alternative materials like metal or wood that is internally secured to the concave spoon portion 14, spatula edge portion 16, and bristle portion 18. In this embodiment, the handle portion 12 can be provided as separable to enable separate cleaning. In this embodiment, a soft grip can be added to the handle portion 12.

The size of the device 10 can vary depending on whether it is intended for use as a grilling utensil or stove top product. The handle portion 12 should be lengthy enough to reach across the grills area and ensure a safe working distance from hot grill. In one embodiment, the end of the handle portion 12 can include a notch or aperture for hanging.

The bristles portion 18 of the present invention comprises a plurality of bristles. The bristles of a device in accordance with the present invention are flexible but are made of higher durometer silicon offering a stiffer action. The use of such “stiffer” but flexible bristles allow users to baste with more control. The bristles should be firm and wide which provide basting capabilities allowing liquids and sauces to be applied to surfaces of food, including difficult to reach cavities and crevices. In one embodiment, the bristles can have a durometer of around 60 shore to provide suitable rigidity. In various embodiments, the bristles can comprise a single layer, a double layer, a triple layer or other numbers of layers of bristle ends. In one embodiment, 17 bristles can be provided although the invention is not limited to any particular number. In one embodiment the length of the bristles will be about 0.8 inches or less, which has been found to give the user the desired controlled flex necessary to apply sauces, although again the invention is not limited to any bristle length.

The concave spoon portion 14 of the present invention can be preferably integrally formed with the bristle portion 18. The concave spoon portion 14 enables the user to “scooping-out” sauce from a jar or bowl or the like. The concave spoon portion 14 of the present invention comprises a sufficiently deep well to capture a sufficient amount of fluids, making the device 10 more productive in transferring sauces. The sauces then cascade down to the bristles for generous basting capabilities. In one embodiment, the depth of the scoop can be sized for a controlled measure. The concave spoon portion coupled with the bristles further provides the ability to apply more sauce in a controlled manner, in each application.

The spatula edge portion 16 of the present invention can preferably be integrally formed with the concave spoon portion 14 and the bristle portion 18. The spatula edge portion 16 can be comprised about the concave spoon portion 14, with the two sides 16 coming to a thinner/sharper edge to act as a spatula blade. The spatula edge portion 16 acts as a spatula blade, which provides an edge that enhances a scraping “squeegee” like action enabling the user to scraping the sides of a jar or bowl or the like to eliminate waste. In one embodiment, the device 10 can be provided with a plurality of spatula blades. In a further embodiment, the plurality of spatula blades can comprise one blade being more flexible relative to the other blade, thus providing the user with a choice of which to use.

The spatula edge portion 16, concave spoon portion 14, and the bristle portion 18 of the present invention can preferably be made of “high-temperature” silicon which can have heat resistance up to about 650 F/350 C degrees. The use of such materials further results in a non-stick design. The present invention can be offered in small, medium, and large sizes to accommodate a user's preference. The present invention could also be used for additional applications such as for example applying frosting on cake, etc.

Thus, a combination basting brush, spoon, and spatula in accordance with the principles of the present invention is easy to clean, dishwasher safe, difficult to stain, virtually unlimited color offerings with the silicon material, and silicon will not scratch cookware, high-end stoves, etc.

It should be understood that various changes and modifications to the preferred embodiments described herein would be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A cooking utensil comprising a combination basting brush, spoon, and spatula.

2. The cooking utensil of claim 1 further being formed of a one piece molded silicon.

3. The cooking utensil of claim 1 further comprising a handle portion and a combined concave spoon portion, spatula edge portion, and bristle portion.

4. The cooking utensil of claim 3 further wherein the handle is comprised of a different material than the combined concave spoon portion, spatula edge portion, and bristle portion.

5. The cooking utensil of claim 3 further wherein the handle made is lengthy enough to reach across the grills area and ensure a safe working distance from hot grill.

6. The cooking utensil of claim 1 further wherein the basting brush comprises a plurality of bristles.

7. The cooking utensil of claim 6 further wherein the plurality of bristles are flexible but sufficiently firm to provide basting capabilities to surfaces of food, including difficult to reach cavities and crevices.

8. The cooking utensil of claim 7 further wherein the plurality of bristles can have a durometer of about 60 shore.

9. The cooking utensil of claim 6 further wherein the plurality of bristles is selected from the group comprising a single layer, a double layer, a triple layer or other numbers of layers of bristle ends.

10. The cooking utensil of claim 1 further wherein the spoon comprises a sufficiently deep well to capture an amount of fluids.

11. The cooking utensil of claim 1 further wherein the spoon comprises a well sized for a controlled measure.

12. The cooking utensil of claim 1 further wherein the spatula comprises at least one spatula blade.

13. The cooking utensil of claim 1 further wherein the spatula comprises a plurality of spatula blade.

14. The cooking utensil of claim 13 further wherein the plurality of spatula blades comprises one blade being more flexible relative to the other blade.

15. A cooking utensil comprising a combination basting brush and spoon.

16. The cooking utensil of claim 15 further comprising a spatula.

17. The cooking utensil of claim 15 further being formed of a one piece molded silicon.

18. The cooking utensil of claim 15 further comprising a handle portion and a combined concave spoon portion and a bristle portion.

19. The cooking utensil of claim 15 further wherein the basting brush comprises a plurality of bristles.

20. The cooking utensil of claim 15 further wherein the spoon comprises a sufficiently deep well to capture an amount of fluids.

21. The cooking utensil of claim 15 further wherein the spoon comprises a well sized for a controlled measure.

22. A cooking utensil comprising a combination basting brush and spatula.

23. The cooking utensil of claim 22 further comprising a spoon.

24. The cooking utensil of claim 22 further being formed of a one piece molded silicon.

25. The cooking utensil of claim 22 further comprising a handle portion and a combined concave spatula edge portion and bristle portion.

26. The cooking utensil of claim 22 further wherein the basting brush comprises a plurality of bristles.

27. The cooking utensil of claim 22 further wherein the spatula comprises at least one spatula blade.

28. The cooking utensil of claim 22 further wherein the spatula comprises a plurality of spatula blade.

29. The cooking utensil of claim 22 further wherein the plurality of spatula blades comprises one blade being more flexible relative to the other blade.
